(19) United States
(12) Patent Application Publication
(10) Pub. No.: US 2007/0295802 A1
(43) Pub. Date: Dec. 27, 2007

(54) ACCOUNT INFORMATION ANALYSIS

(75) Inventor: Ray Thompson, Bellevue, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/425,637

(22) Filed: Jun. 21, 2006

(51) Int. Cl. G06Q 40/00

(52) U.S. Cl. 235/379

(57) ABSTRACT

Methods, systems, and machine-readable media are disclosed for managing financial data associated with a plurality of financial service providers. According to one embodiment, a method of managing financial data associated with a plurality of financial service providers can comprise receiving a set of criteria for identifying one or more accounts for one of the financial service providers. The criteria can specify an environment in which the financial data is stored, the environment comprising a plurality of categories for storing the financial data. The criteria can also include a date criterion. The one or more accounts can be identified based on the set of criteria in the environment specified by the criteria. The identified accounts can be evaluated based on the set of criteria. In some cases, the method can further comprise updating the accounts based on the evaluation.

### BACKGROUND OF THE INVENTION

Embodiments of the present invention relate generally to financial transactions. More specifically, embodiments of the present invention relate to methods and systems for managing information that is generated or accumulated in connection with financial transactions.

Databases or other collections of information of various types have grown in complexity and size. For example, financial information related to various accounts and/or transactions of one or more individuals, businesses, or other entities are commonly maintained by one or more financial institutions. This information can include, for example, accounts maintained by or related to one or more financial institutions, personal and/or transaction information related to those accounts, information for managing and/or maintaining those accounts, etc. As the size of these collections of data grow, managing the data and access to the data, searching the data, presenting the search results or other information in a convenient and meaningful way, and maintaining the data becomes more difficult. Hence, there is a need for improved methods and systems for managing large collections of data.

### BRIEF SUMMARY OF THE INVENTION

Methods, systems, and machine-readable media are disclosed for managing financial data associated with a plurality of financial service providers. According to one embodiment, a method of managing financial data associated with a plurality of financial service providers can comprise receiving a set of criteria for identifying one or more accounts for one of the financial service providers. The criteria can specify an environment in which the financial data is stored, the environment comprising a plurality of categories for storing the financial data. The criteria can also include a date criterion. The one or more accounts can be identified based on the set of criteria in the environment specified by the criteria. The identified accounts can be evaluated based on the set of criteria. In some cases, the method can further comprise updating the accounts based on the evaluation.

According to one embodiment, the date criteria can include a date range. In such a case, evaluating the identified accounts can comprise applying an operation indicated by the criteria to accounts of the identified accounts that have transactions within the date range. Alternatively or additionally, the date criteria can include a single date. In such a case, evaluating the identified accounts can comprise applying an operation indicated by the criteria to accounts of the identified accounts that have transactions on the single date, before the single date, or after the single date.

According to another embodiment, the method can further comprise retrieving credit reporting information for an entity related to each of the one or more identified accounts from one or more credit reporting agencies. In such a case, account information for at least one of the one or more identified accounts can be adjusted based on the credit information.

According to yet another embodiment, a summary of the evaluation can be provided. Providing a summary of the evaluation can comprise generating an Excel worksheet. Alternatively or additionally, providing a summary of the evaluation can comprise sending one or more email messages. For example, the criteria can include an indication of one or more email addresses. In such a case, one or more email messages can be sent to addresses indicated in the criteria. A summary of the updating may alternatively or additionally be provided. Providing a summary of the updating can also comprise generating an Excel worksheet and/or sending one or more email messages. For example, the criteria can include an indication of one or more email addresses. In such a case, one or more email messages can be sent to addresses indicated in the criteria.

According to still another embodiment, a method for managing financial data associated with a plurality of financial service providers can comprise receiving a set of criteria for identifying one or more accounts for one of the financial service providers. The criteria can specify an environment in which the financial data is stored. The environment comprising a plurality of categories for storing the financial data. The one or more accounts can be identified based on the set of criteria in the environment specified by the criteria. Credit reporting information for an entity related to each of the one or more identified accounts can be retrieved from one or more credit reporting agencies. Account information for at least one of the one or more identified accounts can be adjusted based on the credit information. The identified accounts can be evaluated based on the set of criteria. In some cases, the method can further comprise updating the accounts based on the evaluation.

According to one embodiment, the criteria can include a date range. In such a case, evaluating the identified accounts can comprise applying an operation indicated by the criteria to accounts of the identified accounts that have transactions within the date range. Alternatively or additionally, the criteria can include a single date. In such a case, evaluating the identified accounts can comprise applying an operation indicated by the criteria to accounts of the identified accounts that have transactions on the single date, before the single date, or after the single date.

According to yet another embodiment, a summary of the evaluation can be provided. Providing a summary of the evaluation can comprise generating an Excel worksheet. Alternatively or additionally, providing a summary of the evaluation can comprise sending one or more email messages. For example, the criteria can include an indication of one or more email addresses. In such a case, one or more email messages can be sent to addresses indicated in the criteria. A summary of the updating may alternatively or additionally be provided. Providing a summary of the updating can also comprise generating an Excel worksheet and/or sending one or more email messages. For example, the criteria can include an indication of one or more email addresses. In such a case, one or more email messages can be sent to addresses indicated in the criteria.

According to still another embodiment, a system can comprise means for receiving a set of criteria for identifying one or more accounts for one of the financial service providers. The criteria can specify an environment in which the financial data is stored while the environment can comprise a plurality of categories for storing the financial data. The criteria can also include a date criterion. The system may also include means for identifying the one or more accounts based on the set of criteria in the environment specified by the criteria. Furthermore, the system can include one or more of means for retrieving credit reporting information for an entity related to each of the one or more identified accounts from one or more credit reporting agencies, means for adjusting account information for at least one of the one or more identified accounts based on the credit information, and means for evaluating the identified accounts based on the set of criteria.

### BRIEF DESCRIPTION OF THE DRAWINGS

FIG. 1 is a block diagram illustrating an exemplary environment in which embodiments of the present invention may be implemented.

FIG. 2 is an exemplary computer system upon which embodiments of the present invention may be implemented.

FIG. 3 illustrates an exemplary user interface for an account information analysis tool through which embodiments of the present invention may be implemented.

FIG. 4 is a flowchart illustrating a process for account information analysis according to one embodiment of the present invention.

FIG. 5 is a flowchart illustrating additional details of a process for account information analysis according to an alternative embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for managing large collections of data. In some such embodiments, the processes are executed by an entity on behalf of one or more client organizations. The description below sometimes provides illustrations that use an example where a client organization is a financial institution, but there is no such requirement for the invention and the methods are intended also to be applicable to other types of organizations that make use of large collections of data. For example, embodiments of the invention may also be used for managing health-care documents or information.

The description herein sometimes refers to “clients” and to “customers.” Reference to “clients” is intended to refer to persons, i.e. individuals, entities, or their agents, on whose behalf a set of information is managed. Reference to “customers” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer.

Generally speaking, embodiments of the present invention provide tools for use in accessing a variety of financial and/or account information a large corpus of account information that may be divided among multiple database and/or systems. These tools can include, but are not limited to, tools for evaluating account information based one a set of criteria including date information, tools for adjusting account information based on credit reporting information, and others.

According to one embodiment of the present invention, a method of managing financial data associated with a plurality of financial service providers, i.e., a tool for evaluating account information based one a set of criteria including date information, can comprise receiving a set of criteria for identifying one or more accounts for one of the financial service providers. The criteria can specify an environment in which the financial data is stored, the environment comprising a plurality of categories for storing the financial data. The criteria can also include a date criterion. The one or more accounts can be identified based on the set of criteria in the environment specified by the criteria. The identified accounts can be evaluated based on the set of criteria. In some cases, the method can further comprise updating the accounts based on the evaluation.

For example, the date criteria can include a date range. In such a case, evaluating the identified accounts can comprise applying an operation indicated by the criteria to accounts of the identified accounts that have transactions within the date range. Alternatively or additionally, the date criteria can include a single date. In such a case, evaluating the identified accounts can comprise applying an operation indicated by the criteria to accounts of the identified accounts that have transactions on the single date, before the single date, or after the single date.

According to another embodiment of the present invention, a method for managing financial data associated with a plurality of financial service providers, i.e., a tool for adjusting account information based on credit reporting information, can comprise receiving a set of criteria for identifying one or more accounts for one of the financial service providers. The criteria can specify an environment in which the financial data is stored. The environment comprising a plurality of categories for storing the financial data. The one or more accounts can be identified based on the set of criteria in the environment specified by the criteria. Credit reporting information for an entity related to each of the one or more identified accounts can be retrieved from one or more credit reporting agencies. Account information for at least one of the one or more identified accounts can be adjusted based on the credit information. The identified accounts can be evaluated based on the set of criteria. In some cases, the method can further comprise updating the accounts based on the evaluation.

Either tool, or any other included in various embodiments of the present invention, can provide a summary of the evaluation. Providing a summary of the evaluation can comprise generating an Excel worksheet. Alternatively or additionally, providing a summary of the evaluation can comprise sending one or more email messages. For example, the criteria can include an indication of one or more email addresses. In such a case, one or more email messages can be sent to addresses indicated in the criteria. A summary of the updating may alternatively or additionally be provided. Providing a summary of the updating can also comprise generating an Excel worksheet and/or sending one or more email messages. For example, the criteria can include an indication of one or more email addresses. In such a case, one or more email messages can be sent to addresses indicated in the criteria.

Each of these tools may be implemented individually or in combination with these or other tools for managing a collection of financial or other data. For example, these tools are thought to be especially useful when integrated in an account information analysis tool such as provided by First Data Corporation for accessing, searching, and managing financial data provided by one or more clients related to any number of customers. While embodiments of the present invention are discussed below and illustrated in the context of such a tool, it should be understood that this context is offered for illustrative purposes only and is not intended to be limiting. Other implementations are contemplated and considered to be within the scope of the present invention.

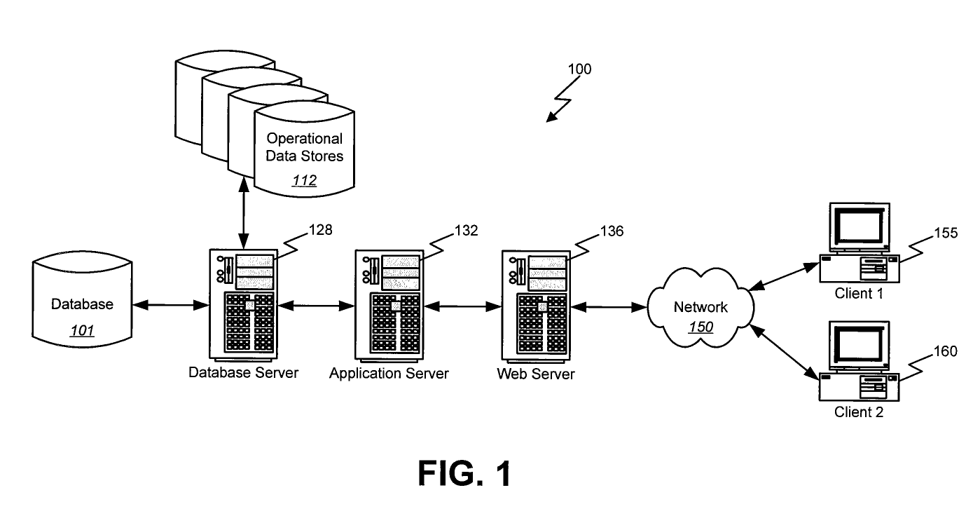

FIG. 1 is a block diagram illustrating an exemplary environment in which embodiments of the present invention may be implemented. In this example, the system 100 can include a database 101 and/or one or more operational data stores 112. The database 101 and/or operational data stores 112 may comprise information collected from or on behalf of such entities as banks, credit unions, trust-management companies, mutual fund companies, discount brokerage firms, and the like. For example, the information can include account numbers, balances, transaction records, personal records, etc. for any number of customer accounts associated with any number of financial institutions or other clients.

Generally speaking, the system 100, as illustrated in FIG. 1, provides an interface with the database 101 and/or data stores 112. Financial-service providers or other clients 155 and 160 that wish to access or perform an analysis based on the data maintained in the database 101 can interface with a web server 136 via a network 150. The network 150 may can be any type of network familiar to those skilled in the art that can support data communications using any of a variety of commercially-available protocols, including without limitation TCP/IP, SNA, IPX, AppleTalk, and the like. Merely by way of example, the network 150 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The web server 136 is itself in communication with an application server 132. The application server 132 communicates with a database server 128 that performs the actual extraction of data. The application server 132 can be configured to execute functions that a user from the financial-service provider may specify through the web server 136. Importantly, while illustrated here as separate servers, the functions of the web server 136, application server 132, and database server may alternatively be implemented in any number of one or more servers.

A number of types of functions may be accessed by the clients 155 and 160 through the web server 136, application server 132 and database server 128. For example, the web server 136 may permit the clients 155 and 166 to prepare a specialized query of the database 101 in which the criteria that define what data is extracted from the database 101 are defined on a case-by-case basis by the user. In some other embodiments, a query may be selected from a menu of preformatted queries. In some embodiments, a mechanism can be provided for allowing queries to be executed on a scheduled basis, such as weekly or monthly. The specialized queries or other functions can include, but are not limited to, tools for evaluating account information based on a set of criteria including date information, tools for adjusting account information based on credit reporting information, etc. Details of each of these tools will be discussed further below.

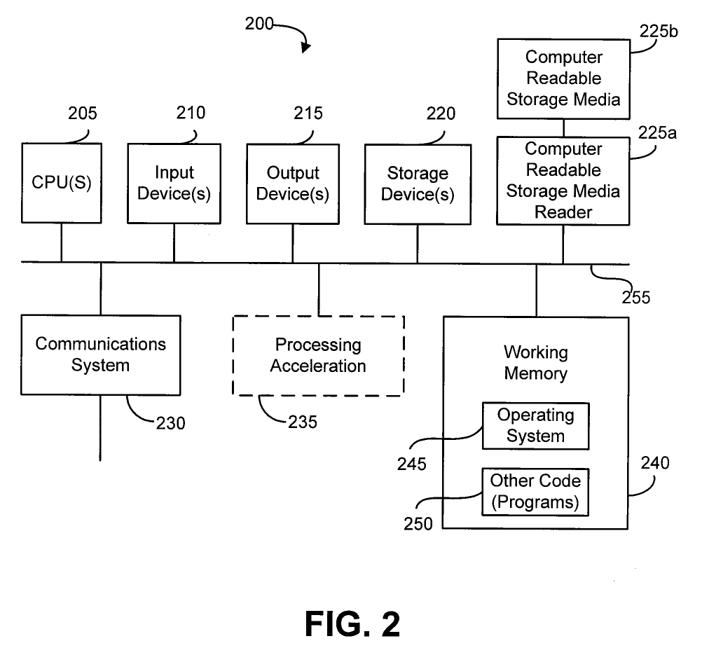

FIG. 2 is an exemplary computer system upon which embodiments of the present invention may be implemented. The computer system 200 is shown comprising hardware elements that may be electrically coupled via a bus 255. The hardware elements may include one or more central processing units (CPUs) 205; one or more input devices 210 (e.g., a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 2000 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement components of a strategic communications system, and/or the methods of the invention. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

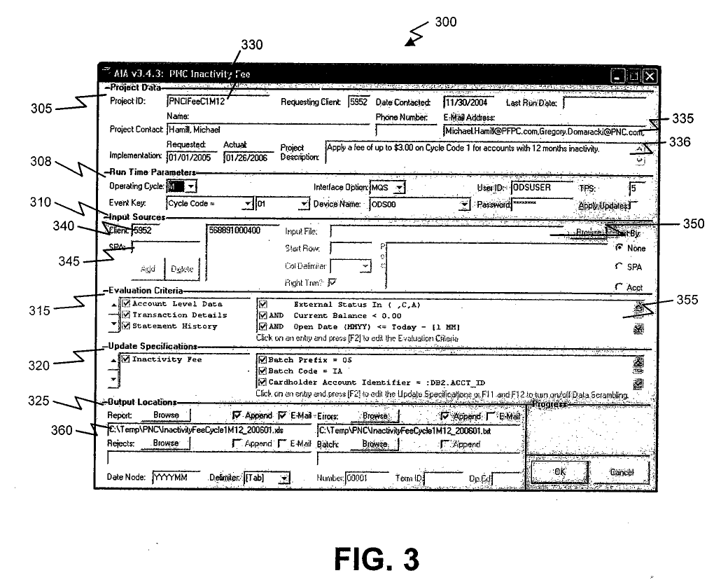

FIG. 3 illustrates an exemplary user interface for an account information analysis tool through which embodiments of the present invention may be implemented. This example illustrates an interface that may be presented to a client accessing a web server via a web browser to search or otherwise access a set of information maintained in a database as discussed above with reference to FIG. 1. More specifically, this example illustrates the main window 300 of the First Data Account Information Analysis tool through which embodiments of the present invention may be implemented. However, as noted above, it should be understood that this context is offered for illustrative purposes only and is not intended to be limiting. Other implementations are contemplated and considered to be within the scope of the present invention.

In this example, the main window 300 of the tool includes a project data section 305, a run time parameters section 308, an input sources section 310, an evaluation criteria section 315, an update specifications section 320 and an output locations section 325. Each of these sections 305-325 can include a number of textboxes, checkboxes, radio buttons, push buttons, and/or other user interface elements through which a user may interact with the interface to control the tools provided through the interface. For example, the project data section 305 can include a textbox 330 for entering a project ID, one or more textboxes 335 for entering contact information, a textbox 336 for entering a description of a project, etc.

Similarly, the input source section 310 of the main window 300 can include a number of textboxes or other elements for identifying one or more sources of account information. For example, the input source section 310 can include a textbox for identifying a client 340 for which account information while be located. The input source section 310 can also include a textbox 350 for identifying an input file containing account information or other information for identifying accounts to be managed. Additionally or alternatively, the input source section 310 can include a textbox 345 for entering information identifying an environment in which account information is stored. For example, account information may be stored in a system such as described above with reference to FIG. 1 in a number of categories or other arrangement. A textbox 345 can be included for identifying such categories or other logical or physical locations.

The evaluation criteria section 315 can include one or more textboxes 355 or other elements for entering or selecting one or more criteria for evaluating account information. For example, via a textbox 355 of the evaluation criteria section 315, a user may be able to specify accounts that are overdrawn, i.e., have an account balance of less than zero, and/or specify accounts that are new, i.e., less than one month since opening, for evaluation. Similarly, the update specification criteria section 320 can include a number of textboxes or other elements for entering or selecting one or more criteria for updating account information.

Finally, the output locations section can include a number of elements 360 for specifying how to handle, i.e., where to send and in what format, results of the evaluation and/or updating of the account information. For example, via the elements 355 of the output locations section 325 a user may be able to specify that output should go to a particular file, in a particular format such as an Excel worksheet. Alternatively or additionally, the user may be able to specify that results should be emailed to a particular recipient or list of recipients such as those identified, for example, in the project data section 305 or elsewhere.

In use, a tool for evaluating account information based on a set of criteria including date information, can receive a set of criteria for identifying one or more accounts for one of the financial service providers via the interface. The criteria can specify, for example via the input sources section 310, an environment in which the financial data is stored, a plurality of categories in which the financial data is stored, etc. The criteria can also include a date criterion specified in the evaluation criteria or elsewhere in the interface. The one or more accounts can be identified based on the set of criteria in the environment specified by the criteria. The identified accounts can be evaluated based on the set of criteria, including those indicated in the evaluation criteria section 315. In some cases, the method can further comprise updating the accounts based on the evaluation and/or criteria from the update specification section 320.

According to another embodiment, a tool for adjusting account information based on credit reporting information can receive a set of criteria for identifying one or more accounts for one of the financial service providers via the interface. The criteria can specify, for example via the input sources section 310, an environment in which the financial data is stored, a plurality of categories in which the financial data is stored, etc. The one or more accounts can be identified based on the set of criteria in the environment specified by the criteria. Credit reporting information for an entity related to each of the one or more identified accounts can be retrieved from one or more credit reporting agencies. Account information for at least one of the one or more identified accounts can be adjusted based on the credit information. The identified accounts can be evaluated based on the set of criteria, including those indicated in the evaluation criteria section 315. In some cases, the method can further comprise updating the accounts based on the evaluation based on the evaluation and/or criteria from the update specification section 320.

Either tool, or any other included in various embodiments of the present invention, can provide a summary of the evaluation and/or updating based on criteria specified in the output locations section 325. Providing a summary of the evaluation can comprise generating an Excel worksheet. Alternatively or additionally, providing a summary of the evaluation can comprise sending one or more email messages. For example, the criteria from the project data section 305 or elsewhere can include an indication of one or more email addresses. In such a case, one or more email messages can be sent to addresses indicated in the criteria.

It should be noted that the preceding user interface has been offered by way of example and not limitation. Rather, any of a variety of possible textual and/or graphical interfaces may be implemented without departing from the scope of the present invention. For example, in some cases, a purely textual interface, such as used with a terminal emulator, may be used. In other cases, various other formats, either textual, graphical, or some combination thereof may be used.

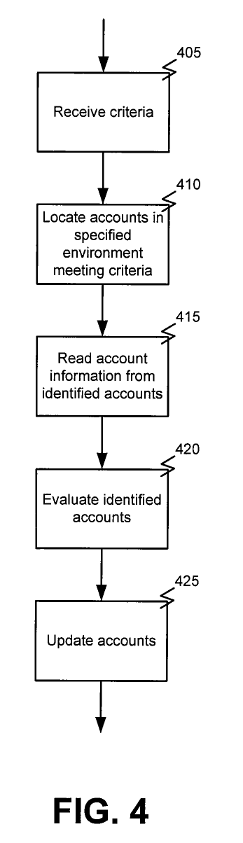

FIG. 4 is a flowchart illustrating a process for account information analysis according to one embodiment of the present invention. In this example, processing begins with receiving 405 a set of criteria for identifying one or more accounts for one of the financial service providers. As noted above, the criteria can specify an environment in which the financial data is stored. For example, the environment can comprise a plurality of categories (i.e., system, prin, agent, etc.) for storing the financial data. Also as noted above, the criteria can also include a date criterion.

The one or more accounts can be identified 410 based on the set of criteria in the environment specified by the criteria. That is, based on criteria, for example, selection criteria entered through an interface such as discussed above with reference to FIG. 3 and including one or more indications of an environment (i.e., system, prin, agent, etc.) and/or other search or identification criteria, one or more accounts can be located/identified and the account information can be read 415.

The identified accounts can be evaluated 420 based on the set of criteria. According to one embodiment, the date criteria can include a date range. In such a case, evaluating 420 the identified accounts can comprise applying an operation indicated by the criteria to accounts of the identified accounts that have transactions within the date range. Alternatively or additionally, the date criteria can include a single date. In such a case, evaluating 420 the identified accounts can comprise applying an operation indicated by the criteria to accounts of the identified accounts that have transactions on the single date, before the single date, or after the single date. Operations applied to the account information can include any of a variety of possible operations. By way of example and not limitation, such operation can include, selecting accounts that have an opening date on, before, or after a specified date, selecting accounts that have transactions occurring within a specified date range, selecting accounts that have been closed or opened since a specified date, etc.

In some cases, the accounts can also be updated 425 based on the evaluation 425. For example, accounts that have been opened since a specified date may have a maintenance fee applied. In another example, accounts that have been renewed within a specified period may receive a credit, credit limit increase or other incentive. In another example, accounts set to expire within a specified period may be marked to receive notice of a promotion or other incentive for renewal. Other updates applied to the account information are also contemplated and considered to be within the scope of the present invention.

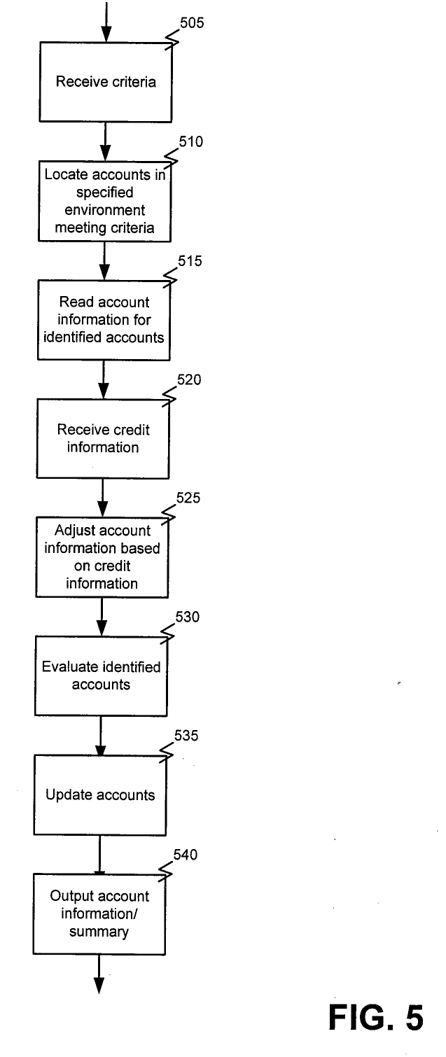

FIG. 5 is a flowchart illustrating additional details of a process for account information analysis according to an alternative embodiment of the present invention. In this example, the tool for evaluating account information based one a set of criteria including date information as described above with reference to FIG. 4 has been combined with a tool for adjusting account information based on credit reporting information. As noted above, these tools can be used individually, in combination with one another as shown here, or in combination with one or more other tools.

In the example illustrated in FIG. 5, processing also begins with receiving 505 a set of criteria for identifying one or more accounts for one of the financial service providers. As noted above, the criteria can specify an environment in which the financial data is stored. For example, the environment can comprise a plurality of categories (i.e., system, prin, agent, etc.) for storing the financial data. The criteria can also optionally include a date criterion as discussed above.

The one or more accounts can be identified 510 based on the set of criteria in the environment specified by the criteria. That is, based on criteria, for example, selection criteria entered through an interface such as discussed above with reference to FIG. 3 and including one or more indications of an environment (i.e., system, prin, agent, etc.) and/or other search or identification criteria, one or more accounts can be located/identified and the account information can be read 515.

Credit reporting information for an entity related to each of the one or more identified accounts can be retrieved 520 from one or more credit reporting agencies. For example, a request can be made to a credit reporting agency for one or more of the identified accounts. Alternatively or additionally, credit reporting information can be requested based on the set of criteria, i.e., based on an indication of one or more individuals, accounts, etc. In another example, credit reporting information related to one or more accounts can be requested and saved based on any of a variety of criteria such as defined in control information or elsewhere. For example, control information can define a period or event upon which credit information for an entity can be retrieved or requested from a credit reporting agency. In such a case, the credit reporting information can be saved and used when the account information is read.

According to one embodiment, the account information for at least one of the one or more identified accounts can be adjusted 525 based on the credit information. For example, the account information may include a credit limit or other such limit for an account balance. In such a case, the limit can be adjusted up or down based on a credit score, balances on other accounts, late payments, defaults, or other information from the credit reporting agencies.

Furthermore, the identified accounts can be evaluated 530 based on the set of criteria such as described above. These criteria may or may not include one or more date criteria as discussed. As noted above, evaluating 530 the identified accounts can comprise applying an operation indicated by the criteria to accounts of the identified accounts. Alternatively or additionally, the evaluation may include applying operations to the account information based on the credit reporting information. For example, rather than a separate operation to adjust the account information based on the credit information, evaluation of the account information can include such operations. Alternatively or additionally, evaluation can include providing other operations or functions based on adjustments to the accounts. For example, notices to one or more entities may be generated in the event that account information is adjusted based on credit information. Other operations applied to the account information can include any of a variety of possible operations such as those discussed above. Also as noted above, the accounts can be updated 535 based on the evaluation.

According to yet another embodiment, a summary of the evaluation and/or updating of the account information can be provided 540. Providing 540 a summary of the evaluation and/or updating can comprise generating an Excel worksheet. Alternatively or additionally, providing a summary of the evaluation and/or updating can comprise sending one or more email messages. For example, the criteria can include an indication of one or more email addresses. In such a case, one or more email messages can be sent to addresses indicated in the criteria.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing financial data associated with a plurality of financial service providers, the method comprising:
receiving a set of criteria for identifying one or more accounts for one of the financial service providers, wherein the criteria specify an environment in which the financial data is stored, the environment comprising a plurality of categories for storing the financial data, and wherein the criteria include a date criterion;
identifying the one or more accounts based on the set of criteria in the environment specified by the criteria; and
evaluating the identified accounts based on the set of criteria.

2. The method of claim 1, further comprising updating the accounts based on the evaluation.

3. The method of claim 1, wherein the date criteria include a date range.

4. The method of claim 3, wherein evaluating the identified accounts comprises applying an operation indicated by the criteria to accounts of the identified accounts that have transactions within the date range.

5. The method of claim 1, wherein the date criteria include a single date.

6. The method of claim 5, wherein evaluating the identified accounts comprises applying an operation indicated by the criteria to accounts of the identified accounts that have transactions on the single date.

7. The method of claim 5, wherein evaluating the identified accounts comprises applying an operation indicated by the criteria to accounts of the identified accounts that have transactions before the single date.

8. The method of claim 5, wherein evaluating the identified accounts comprises applying an operation indicated by the criteria to accounts of the identified accounts that have transactions after the single date.

9. The method of claim 1, further comprising:
retrieving credit reporting information for an entity related to each of the one or more identified accounts from one or more credit reporting agencies; and
adjusting account information for at least one of the one or more identified accounts based on the credit information.

10. The method of claim 1, further comprising providing a summary of the evaluation.

11. The method of claim 10, wherein providing a summary of the evaluation comprises generating an Excel worksheet.

12. The method of claim 10, wherein providing a summary of the evaluation comprises sending one or more email messages.

13. The method of claim 12, wherein the criteria include an indication of one or more email addresses and sending one or more email messages comprises sending email messages to addresses indicated in the criteria.

14. The method of claim 2, further comprising providing a summary of the updating.

15. The method of claim 14, wherein providing a summary of the updating comprises generating an Excel worksheet.

16. The method of claim 14, wherein providing a summary of the updating comprises sending one or more email messages.

17. The method of claim 16, wherein the criteria include an indication of one or more email addresses and sending one or more email messages comprises sending email messages to addresses indicated in the criteria.

18. A method for managing financial data associated with a plurality of financial service providers, the method comprising:
receiving a set of criteria for identifying one or more accounts for one of the financial service providers, wherein the criteria specify an environment in which the financial data is stored, the environment comprising a plurality of categories for storing the financial data;
identifying the one or more accounts based on the set of criteria in the environment specified by the criteria;
retrieving credit reporting information for an entity related to each of the one or more identified accounts from one or more credit reporting agencies; and
adjusting account information for at least one of the one or more identified accounts based on the credit information.

19. The method of claim 18, further comprising evaluating the identified accounts based on the set of criteria.

20. The method of claim 19, further comprising updating the accounts based on the evaluation.

21. The method of claim 18, wherein the criteria include a date range.

22. The method of claim 21, wherein evaluating the identified accounts comprises applying an operation indicated by the criteria to accounts of the identified accounts that have transactions within the date range.

23. The method of claim 18, wherein the criteria include a single date.

24. The method of claim 23, wherein evaluating the identified accounts comprises applying an operation indicated by the criteria to accounts of the identified accounts that have transactions on the single date.

25. The method of claim 23, wherein evaluating the identified accounts comprises applying an operation indicated by the criteria to accounts of the identified accounts that have transactions before the single date.

26. The method of claim 23, wherein evaluating the identified accounts comprises applying an operation indicated by the criteria to accounts of the identified accounts that have transactions after the single date.

27. The method of claim 19, further comprising providing a summary of the evaluation.

28. The method of claim 27, wherein providing a summary of the evaluation comprises generating an Excel worksheet.

29. The method of claim 27, wherein providing a summary of the evaluation comprise sending one or more email messages.

30. The method of claim 29, wherein the criteria include an indication of one or more email addresses and sending one or more email messages comprises sending email messages to addresses indicated in the criteria.

31. The method of claim 20, further comprising providing a summary of the updating.

32. The method of claim 31, wherein providing a summary of the updating comprises providing an Excel worksheet.

33. The method of claim 31, wherein providing a summary of the updating comprise sending one or more email messages.

34. The method of claim 33, wherein the criteria include an indication of one or more email addresses and sending one or more email messages comprises sending email messages to addresses indicated in the criteria.

35. A system comprising:
a communication network;
a plurality of data stores communicatively coupled with the network and adapted to maintain financial account information associated with a plurality of financial service providers;
a client device communicatively coupled with the communication network; and
a server communicatively coupled with the communication network and adapted to receiving from the client device a set of criteria for identifying one or more accounts for one of the financial service providers, wherein the criteria specify an environment in which the financial data is stored, the environment comprising a plurality of categories for storing the financial data, and wherein the criteria include a date criterion; identify the one or more accounts based on the set of criteria in the environment specified by the criteria; retrieve credit reporting information for an entity related to each of the one or more identified accounts from one or more credit reporting agencies, and adjust account information for at least one of the one or more identified accounts based on the credit information, and means for evaluating the identified accounts based on the set of criteria.
